(19) United States
(12) Patent Application Publication
(10) Pub. No.: US 2018/0229947 A1
(43) Pub. Date: Aug. 16, 2018

(54) Positioning System Comprising a Magnet Arrangement

(71) Applicant: FESTO AG & Co. KG, Esslingen (DE)

(72) Inventor: Thomas Feyrer, Esslingen (DE)

(21) Appl. No.: 15/751,677

(22) PCT Filed: Aug. 11, 2015
(86) PCT No.: PCT/EP2015/068459

§ 371 Date: Feb. 9, 2018

(51) Int. Cl. B65G 54/02; B65G 51/03; H02K 7/09; H02K 41/03; G03B 21/64

(52) U.S. Cl. CPC B65G 54/02; B65G 51/03; G03B 21/64; H02K 41/031; H02K 7/09

(57) ABSTRACT

A positioning system has at least one positioning carriage which is variably mobile and positionable relative to a carriage support of the positioning system, whilst carrying out a positioning movement on a positioning plane defined by an xy cartesian co-ordinate system, the carriage support having at least one stator arrangement with an x-stator section for providing a magnetic x-travelling field, which can be moved in the direction of the x-axis of the xy co-ordinate system, and a y-stator section for providing a magnetic y-travelling field, which can be moved in the direction of the y-axis of the xy co-ordinate system. The positioning carriage is provided with a magnet arrangement which, during the positioning movement, magnetically interacts simultaneously with the x-travelling field and the y-travelling field.

The invention relates to a positioning system with at least one positioning carriage which can be variably moved and positioned relative to a carriage support of the positioning system by executing a positioning movement in a positioning plane defined by a Cartesian x-y coordinate system.

A positioning system known from DE 1920556 A contains a positioning carriage formed as a table top, which is two-dimensionally adjustable with respect to a frame-shaped carrier support in a positioning plane spanned by a Cartesian coordinate system. The positioning system comprises an x-drive gear and a y-drive gear, which are rotationally mounted on the carriage support and whose axes of rotation are aligned at right angles to one other. Multiple tooth racks formed on the positioning carriage and extending at right angles to one another are in toothed engagement with each of these drive gears. By overlapping rotational movements of the x-drive gear and the y-drive gear positioning movements of the positioning be generated, in which movement directions in the x-axis direction and in the y-axis direction overlap.

The object of the invention is to provide an improved positioning system.

This object is achieved for a positioning system of the type described in the introduction with the features of claim 1.

The positioning system according to the invention comprises a stator arrangement, which has an x-stator section and a y-stator section, arranged on the carriage support. The x-stator section serves to provide a travelling magnetic field movable in the x-axis direction, while the y-stator section serves to provide a travelling magnetic field movable in the y-axis direction.

The positioning carriage has a magnet arrangement that magnetically interacts with the x travelling field and the y travelling field during the positioning movement. The positioning carriage can be driven by moving the x travelling field to a positioning movement in the x-axis direction of the x-y coordinate system and by moving the y-travelling field to a positioning movement in the y-axis direction of the x-y coordinate system.

According to the invention the magnet arrangement of the positioning carriage comprises a variety of magnetic poles distributed in a plane parallel to the positioning plane. The magnetic poles are in particular magnetic north and south poles oriented perpendicular to the positioning plane. The poles may be provided for example by a plurality of permanent magnets that are aligned in their magnetisation direction perpendicular to the positioning plane. The magnetic poles mentioned hereinafter are preferably the poles of the permanent magnets oriented towards the carriage support. The magnetic poles are placed at crossing points of mutually orthogonal x-gridlines and y-gridlines of an imaginary grid lattice in such a way that magnetic poles placed on the same x-gridlines have the same pole alignment with respect to one another, and magnetic poles placed on the same y-gridlines have the same pole alignment with respect to one another, wherein the pole alignment of the magnetic poles alternates in the diagonal direction of the x-y coordinate system.

The magnetic poles are thus placed at crossing points of an imaginary grid lattice and consequently are arranged in the manner of a matrix. Only magnetic poles that have the same pole alignment with respect to one another are respectively placed on the same x-gridlines. In particular, exclusively magnetic north poles or exclusively magnetic south poles are respectively placed on the x-gridlines. For example, exclusively magnetic north poles are placed on a first x-gridline and exclusively magnetic south poles are placed on a second x-gridline. In particular, magnetic north and south poles are not provided on any of the x-gridlines at the same time. An x-gridline on which exclusively magnetic north poles or south poles are placed is hereinafter also referred to as a north pole line or south pole line.

Corresponding to the previously described placement with regard to the x-gridlines, only magnetic poles that have the same polar alignment are respectively placed on the same y-gridlines. In particular exclusively magnetic north poles or exclusively magnetic south poles are respectively placed on the y-gridlines. A y-gridline on which exclusively magnetic north poles or south poles are placed is hereinafter also referred to as north pole row or south pole row.

As mentioned above, the magnetic poles on the imaginary grid lattice are also arranged so that the pole alignment of the magnetic poles alternates in the diagonal direction of the x-y coordinate system.

In connection with the property discussed above, namely that respectively only magnetic poles with the same orientation are placed on the x- and y-gridlines, a matrix-like magnet arrangement is thus obtained, in which north pole lines and south pole lines are arranged alternately to another in the y-axis direction, and north pole rows and south pole rows are arranged alternately to one another in the x-axis direction. No magnetic pole is provided at every second crossing point in the x-axis direction and in the y-axis direction. The magnetic poles of adjacent rows are respectively shifted with respect to one another about a crossing point in the x-axis direction, and the magnetic poles of adjacent rows are respectively shifted with respect to one another about a crossing point in the y-axis direction.

The grid lattice defining the distribution of the magnetic poles expediently has a regular structure, in which the x-gridlines have in particular the same spacing from one another as the y-gridlines. The magnet arrangement is expediently located on an underneath side of the positioning carriage facing towards the carriage support.

The x-travelling field is designed so that by the movement of the x-travelling field, the movement and position of the positioning carriage is determined in the x-axis direction. For this purpose, the x-stator section is in particular designed to generate as x-travelling field a magnetic field with a plurality of wavefronts parallel to the y-axis direction. The x-travelling field along the x-axis direction preferably has sections with maximum magnetic field strength at periodic intervals. The magnetic field direction of these sections preferably alternates along the x-axis direction and in particular corresponds to the pole alignment of the magnetic north or south poles of the magnet arrangement. The sections of maximum field strength with magnetic field direction opposite to the pole alignment of the magnetic north poles of the magnet arrangement are hereinafter also referred to as north pole sections, since they are repelled by the north poles of the magnet arrangement. Analogously to this, the sections of maximum field strength with magnetic field direction opposite to the pole orientation of the magnetic south poles are also referred to below as south pole sections. Expediently the distance between two adjacent sections of maximum magnetic field strength—i.e. the distance between a north pole section and an adjacent south pole section—corresponds to the distance between two crossing points on an x-gridline of the afore-described imaginary grid lattice, or a fraction or multiple thereof. In the y-axis direction the x-travelling field is preferably substantially constant.

The y-travelling field is formed corresponding to the afore-described x-travelling field. That is, the y-travelling field is formed so that the movement and position of the positioning carriage in the y-axis direction is determined by the y-travelling field. The y-stator section is conveniently designed to generate as y-travelling field a magnetic field having a plurality of wavefronts parallel to the x-axis direction. Preferably the y-travelling field along the y-axis direction periodically has sections with maximum magnetic field strength. The magnetic field direction of these sections preferably alternates along the y-axis direction. In particular, the y-travelling field has alternating north pole sections and south pole sections along the y-axis direction. Expediently, the distance between two adjacent sections of maximum magnetic field strength—i.e. a north pole section and an adjacent south pole section—corresponds to the distance between two crossing points on a y-gridline of the afore-described imaginary grid lattice, or a fraction or multiple thereof. In the x-axis direction, the y-travelling field is preferably substantially constant.

A shift of the positioning carriage in the x-axis direction can be effected by means of an x-axis travelling magnetic field generated by the x-stator section, moving in the x-axis direction, and the resulting driving cooperation between the x-travelling magnetic field and the magnetic poles of the magnet arrangement, wherein those magnetic poles of the magnet arrangement that are at the same time in magnetic interaction with the magnetic y-travelling field are to some extent guided in a linearly displaceable manner in the x-axis direction, since the y-travelling field is substantially constant in the x-axis direction as described above. This takes place in a comparable way in the reverse sense also with a y-travelling magnetic field generated by the y-stator section, moving in the y-axis direction. By mutually coordinated movement of at least one x-travelling field magnetically interacting with the magnet arrangement and a y-travelling field also magnetically interacting at the same time with the magnet arrangement, the positioning carriage can be displaced in the positioning plane with any desired direction of movement. The possibility of the cooperation of the magnet arrangement with the at least one x-travelling field and also the at least one y-travelling field makes it possible to realise a positioning region of the positioning carriage that is relatively large in area. In particular, there is also the advantage that the base area of the carriage support can be optimally utilised for the positioning movement of the positioning carriage, wherein an arrangement is even possible in which the positioning carriage projects beyond the carriage support edge.

The carriage support of the positioning system can be designed as a single support unit, which has available at least one x-stator section and at least one y-stator section, but which can also be equipped with a multiple number of an x-stator section and/or a y-stator section.

Advantageous embodiments of the invention follow from the dependent claims.

In one embodiment of the invention it is envisaged that between the carriage support and the positioning carriage at least one bearing device is arranged, which movably supports the positioning carriage in the x-axis direction and y-axis direction and is preferably designed as a slide bearing device, air bearing device, rolling bearing device, ball bearing device or magnetic bearing device.

Preferably, the at least one positioning carriage with its magnet arrangement lies loosely on the bearing device above the stator arrangement. The magnet arrangement is preferably always located simultaneously over at least one x-stator section and/or at least one y-stator section. Preferably, the positioning system is designed so that the magnet arrangement always rests simultaneously on an x-stator section and on a y-stator section.

The positioning carriage can in particular rest, with a magnet arrangement arranged on its underneath side, from above on the bearing device above the x-stator section and the y-stator section of the stator arrangement. This offers the advantageous possibility that, when assembling the positioning system, each positioning carriage may simply be placed from above onto the carriage support or the bearing device, so that it is in magnetic interaction with at least two stator sections. Conversely, each positioning carriage also can be removed again from the carriage support by simply lifting it off, if necessary. The positioning carriage conveniently has no component that engages underneath a component of the carriage support.

In a further embodiment of the invention it is envisaged that the bearing device comprises an air cushioning plate, which expediently has on the side facing the positioning carriage a plurality of air outlet openings for providing an air bearing supporting the positioning carriage.

The air cushioning plate is conveniently arranged in a plane parallel to the positioning plane. Preferably, a plurality of air cushioning plates is provided, which rest against one another on the carriage support. In particular, the air cushioning plates have a rectangular, preferably a square, outline. Preferably, the air cushioning plates are glass plates. Alternatively to this, the air cushioning plates can be made of a porous material, wherein pores arranged on the upper side—that is to say on the side facing the carriage—serve as the abovementioned air outlet openings.

In a further embodiment of the invention it is envisaged that the carriage support has at least one winding chamber, in which a winding arrangement of the stator arrangement is arranged, wherein the winding chamber is closed in the direction to the positioning carriage by the air cushioning plate, and, on the side of the winding arrangement facing away from the air cushioning plate, has a compressed air inlet, so that compressed air for the air bearing provided at the compressed air inlet must flow through the winding chamber and the winding arrangement in order to reach the air outlet openings.

The winding arrangement includes, for example, a plurality of current-carrying leads, with which the afore-described x- and y-travelling fields are provided. This winding arrangement is housed in the carriage support in a winding chamber. Upwardly—i.e. towards the positioning carriage—this winding chamber is covered or closed by the afore-described air cushioning plate. As described above, a plurality of air outlet openings are provided in the air cushioning plate, from which supplied compressed air can exit in order to support the positioning carriage. The carriage support is designed so that the supplied compressed air first of all flows through the winding chamber and therefore also through the winding arrangement, before it reaches the air outlet openings and exits from these. This is achieved in that the compressed air inlet is arranged on a side of the winding arrangement facing away from the air cushioning plate, so that the supplied compressed air necessarily has to flow through the winding arrangement to reach the air outlet openings. For example, the compressed air inlet is, for this purpose, located on the base of the winding chamber. Expediently, apart from the air outlet openings and the compressed air inlet, the winding chamber is formed airtight. The described embodiment of the winding chamber provides the advantage that the winding arrangement can be cooled with the compressed air supplied for providing the air bearing.

In a further embodiment of the invention it is envisaged that the at least one positioning carriage is designed as a product carrier, which can be loaded directly or indirectly with at least one product to be positioned.

The positioning carriage can be equipped with fastening means, which allow a preferably releasable securement of at least one product. However, there is also the possibility of using the positioning carriage as a base carrier for an actual product carrier, wherein the actual product carrier may for example be a so-called microtiter plate, which can be used for storing or transporting fluid samples.

In a further embodiment of the invention it is envisaged that the at least one positioning carriage has a rectangular outline and/or is plate-shaped.

Preferably, the positioning carriage represents a pallet. The magnet arrangement expediently has a rectangular outer contour with four mutually right-angle edge regions.

In a further embodiment of the invention it is envisaged that the x-stator section has an x-winding arrangement, which comprises a plurality of leads running parallel to the y-axis direction, and the y-stator section has a y-winding arrangement, which comprises a plurality of leads running parallel to the x-axis direction.

Preferably, the leads of a winding arrangement are subdivided into different groups of leads, which can respectively carry different, preferably mutually phase-shifted, currents, so that a travelling magnetic field is generated. In particular, leads of different groups of leads are arranged next to one another and this arrangement is periodically continued along the corresponding axial direction—i.e. along the x-axis direction in the x-winding arrangement and along the y-axis direction in the y-winding arrangement. The leads can be formed meandering. For example, the leads of the x-winding arrangement can be routed transversely to the x-axis direction from a first side of the x-winding arrangement to an opposite, second side of the x-winding arrangement, and can be routed back again, offset in the x-axis direction, from the second side to the first side. The leads of the y-winding arrangement may be arranged corresponding to this. The winding arrangements preferably occupy rectangular, in particular square, surfaces. Leads, in particular leads of the same group of leads, can also be stacked perpendicular to the positioning plane.

In a further embodiment of the invention it is envisaged that the x-winding arrangement and the y-winding arrangement are arranged parallel to the positioning plane in an L-shaped configuration, wherein an axial end region of the x-winding arrangement is placed adjacent to an axial end region of the y-winding arrangement.

Between the two winding arrangements, a drive circuit for electrically energising the winding arrangements can be provided, for example.

If the carriage support has a rectangular outline, at least one winding arrangement is preferably placed so that the two winding arrangements extend along two side edges of the carriage support meeting in a common corner point.

In a further embodiment of the invention it is envisaged that the x-winding arrangement and the y-winding arrangement are arranged parallel to the positioning plane and occupy at least partially the same x-y region in the x-y-coordinate system, so that the x-travelling field and the y-travelling field are superimposed in this x-y region.

According to this embodiment, the x-winding arrangement and the y-winding arrangement overlap. Preferably, the two winding arrangements overlap completely in this case. The overlapping of the winding arrangements achieves in particular the advantage that the surface of the carriage support is utilised more efficiently and thus travelling magnetic fields extending over a relatively large region can be provided both in the x-axis direction and also in the y-axis direction.

Preferably the leads of the various overlapping winding arrangements are stacked on top of one another perpendicular to the positioning plane. In particular leads of respectively an x-winding arrangement and a y-winding arrangement are alternately stacked on top of one another perpendicular to the positioning plane. In plan view, a winding matrix is formed, which comprises the leads of an x-winding arrangement and a y-winding arrangement.

On account of the overlapping of the winding arrangements the travelling magnetic fields generated by the winding arrangements are superimposed. If, as described above, the travelling magnetic fields have in each case a plurality of parallel wavefronts, the overlapping of the two travelling fields produces a resulting magnetic field, whose magnetic field strength has a plurality of maxima and minima distributed like a matrix over the overlapping surface of the winding arrangements.

The leads of the winding arrangements are preferably arranged and/or electrically energised in such a way that a magnetic field resulting from the superposition is produced, whose magnetic north and south poles are arranged in inverse correspondence to the north and south poles of the afore-described magnet arrangement. The resulting magnetic field is expediently designed so that magnetic south poles are formed at the crossing points of the imaginary grid lattice occupied by north poles of the magnet arrangement, and magnetic north poles are formed at the crossing point occupied by south poles of the magnet arrangement. Due to this formation of the resulting magnetic field, the magnet arrangement of the positioning carriage can be carried along particularly well by the resulting magnetic field.

In a further embodiment of the invention it is envisaged that the x-winding arrangement and the y-winding arrangement are arranged parallel to the positioning plane and have in each case rectangular, preferably square, outlines, wherein the side lengths of the x-winding arrangement and the y-winding arrangement in the x-axis direction and y-axis direction of the x-y coordinate system substantially coincide.

The y-winding arrangement is preferably placed next to the x-winding arrangement, aligned in the x-axis direction or y-axis direction. If the positioning system has multiple x-winding arrangements and y-winding arrangements, these may conveniently be arranged in a chessboard pattern; that is, x-winding arrangements and y-winding arrangements are alternately arranged along the x-axis direction and the y-axis direction.

In a further embodiment of the invention it is envisaged that the carriage support is equipped with a plurality of x-stator sections and/or with a plurality of y-stator sections.

In particular, the carriage support can be equipped with any number of x-stator sections and/or y-stator sections. If the carriage support has available a larger number of x-stator sections and y-stator sections distributed over an area, a particularly large positioning region can be realised in the positioning plane. The positioning carriage can during its positioning movement engage in a magnetic interaction successively with different x-stator sections and/or y-stator sections and can also disengage from these again.

In a further embodiment of the invention it is envisaged that the carriage support has at least one drive circuit which is designed to supply multiple mutually phase-shifted currents to at least one x-stator section and/or at least one y-stator section for the provision of the respective travelling field.

The drive circuit is in particular designed to electrically energise the x- and/or y-stator section in such a way that one or more travelling fields are provided with a predetermined form and movement speed. It should be mentioned that a travelling field does not necessarily have to be in motion, but can also be stationary depending on the desired positioning of the positioning carriage in the x-axis direction or y-axis direction. Furthermore, the travelling field does not necessarily have to move continuously, but instead can also be displaced cyclically for the execution of the desired positioning movement.

Possible electrical energisations of a winding arrangement for generating a travelling magnetic field with a desired form and movement speed are already known from the technical field of electromagnetic synchronous linear motors and are therefore not explained in detail at this point. For example, leads of the winding arrangement can be energised in each case with mutually phase-shifted sinusoidal currents in order to provide the travelling magnetic field.

In a further embodiment of the invention it is envisaged that the drive circuit is designed to supply at least two stator arrangements of the carriage support independently of one another with in each case several mutually phase-shifted currents supply in order to provide independently of one another the travelling magnetic fields associated with the at least two stator arrangements.

Conveniently the travelling magnetic fields can be moved independently of one another by means of the drive circuit. The travelling fields can be moved forwards and/or backwards along the x-axis direction or y-axis direction. Also, different movement speeds for the travelling fields can be specified, in particular also so that one travelling field moves at a different speed from the other travelling field. The positioning system expediently contains control means which enable the travelling fields to move coordinated with one another in order to achieve a respectively desired movement direction and movement velocity of the positioning movement.

In a further embodiment of the invention it is envisaged that the carriage support comprises a plurality of support modules, which are modularly arranged or can be modularly arranged next to one another in the x-axis direction and/or in the y-axis direction and which respectively contain at least one x-stator and/or at least one y-stator section, wherein one and the same positioning carriage can during its positioning movement move over several and expediently over all the support modules.

Such a modular carriage support contains a plurality of support modules, which are modularly arranged or can be modularly arranged next to one another in the x-axis direction and/or in the y-axis direction to form the carriage support. Of these support modules, each support module contains at least one and preferably exactly one x-stator section and/or at least one and preferably exactly one y-stator section. The support modules arranged next to one another are preferably mounted on a support base plate. Preferably, fastening means are provided which fix the support modules arranged next to one another on the carrier base plate, wherein these can be for example screw fastening systems or snap-fit connection systems. Alternatively, the support modules arranged next to one another can also be welded to the carrier base plate. All support modules together form a module matrix representing the carriage support. The modular construction enables carriage supports to be realised having different areal size and/or different outer contours, in order to take account of application-specific circumstances.

The advantageous equipment features mentioned above in connection with the carriage support conveniently apply to each individual support module in the case of a modular construction.

In a further embodiment of the invention it is envisaged that the base area of the magnet arrangement of at least one positioning carriage is greater or smaller than the base area of the carriage support or each support module.

If the carriage support is composed modularly of multiple support modules arranged next to each other, it is possible for one and the same positioning carriage to move over several and preferably over all support modules. By coordinated operation of the stator sections of the individual support modules the positioning carriage can easily be “handed over” between adjacent support modules during its positioning movement. For example, it can be detected by means of an integrated magnetic field measurement when a positioning carriage leaves a support module and interacts magnetically with a stator section of an adjacent support module. Of course, additionally or alternatively other detection means may also be present in order to monitor the current position of the positioning carriage and to process it during its control.

The invention will be explained in more detail with reference to the accompanying drawing, in which:

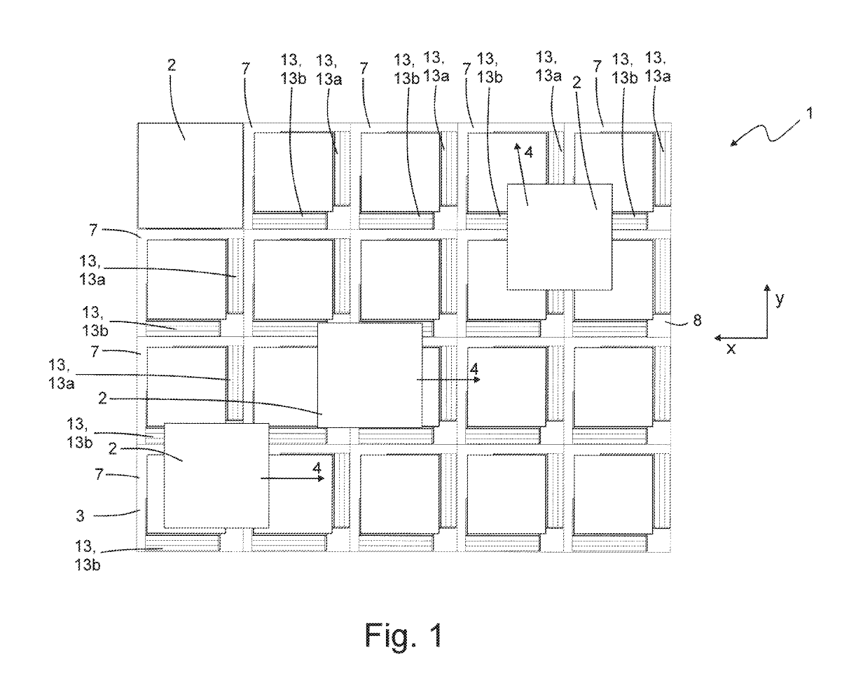

FIG. 1 is a plan view of a first embodiment of the positioning system according to the invention in a view normal to an x-y plane, wherein the carriage support has a modular structure and comprises a plurality of two-dimensional support modules arranged next to one another,

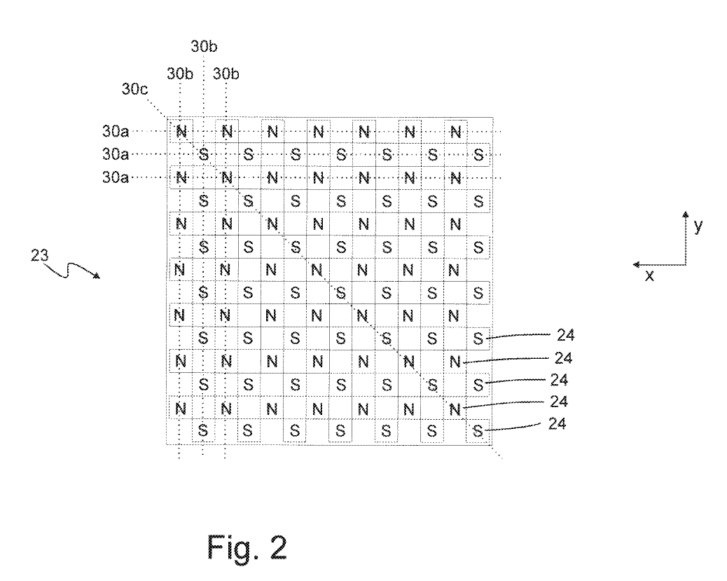

FIG. 2 is a plan view of the magnet arrangement arranged on the carriage support,

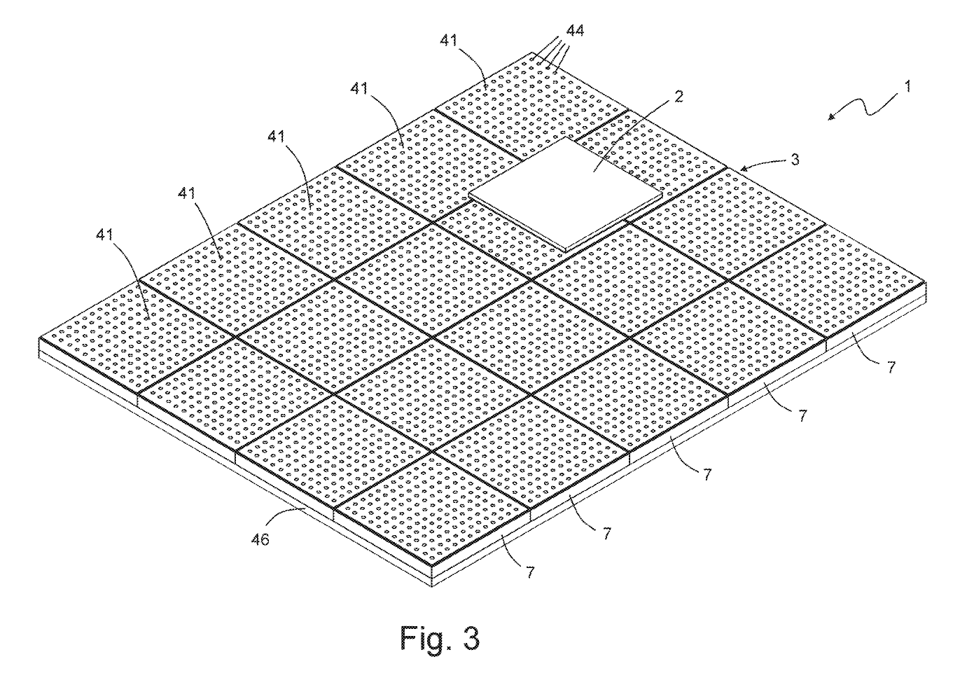

FIG. 3 is an isometric representation of a second embodiment of the positioning system according to the invention, in which a plurality of air cushioning plates is arranged on the carriage support,

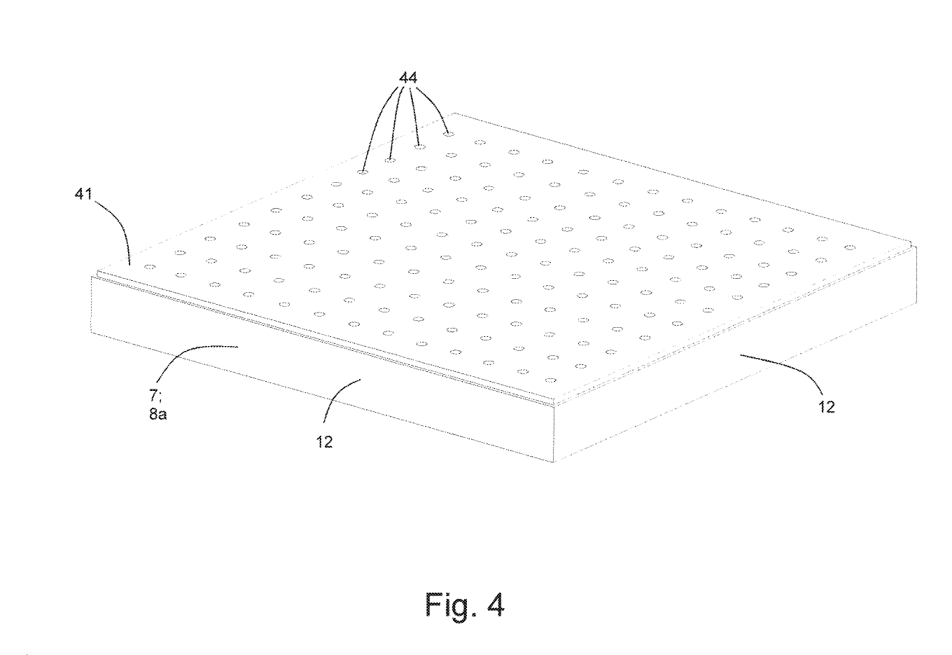

FIG. 4 is an isometric representation of a support module with air cushioning plate,

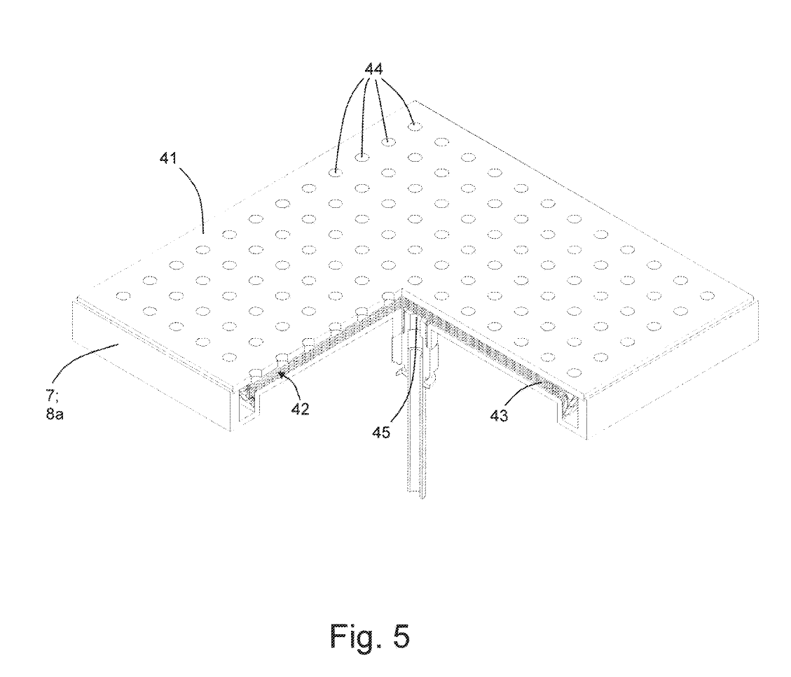

FIG. 5 is an isometric sectional representation of a support module with air cushioning plate and compressed air inlet,

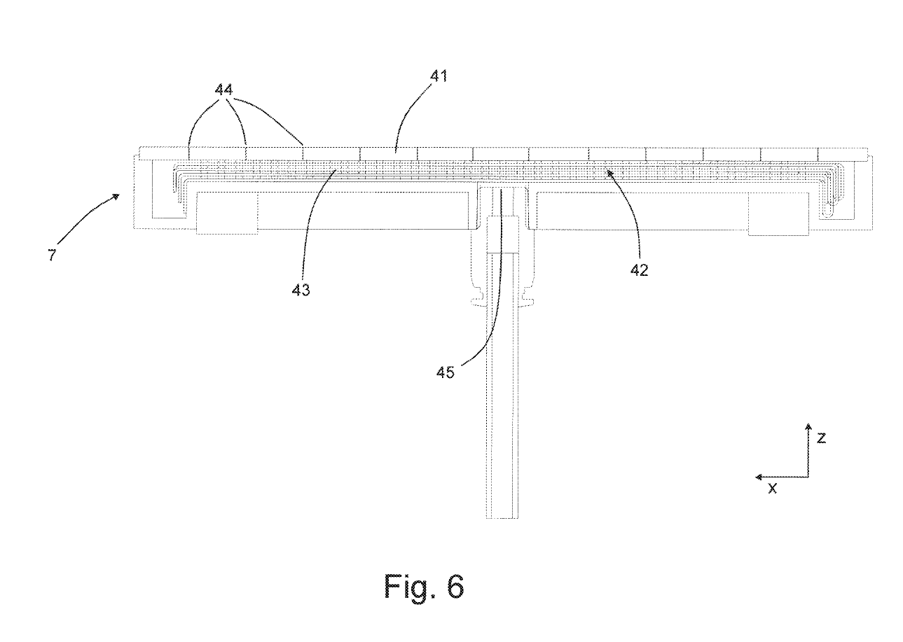

FIG. 6 is a sectional view of a support module with air cushioning plate and compressed air inlet,

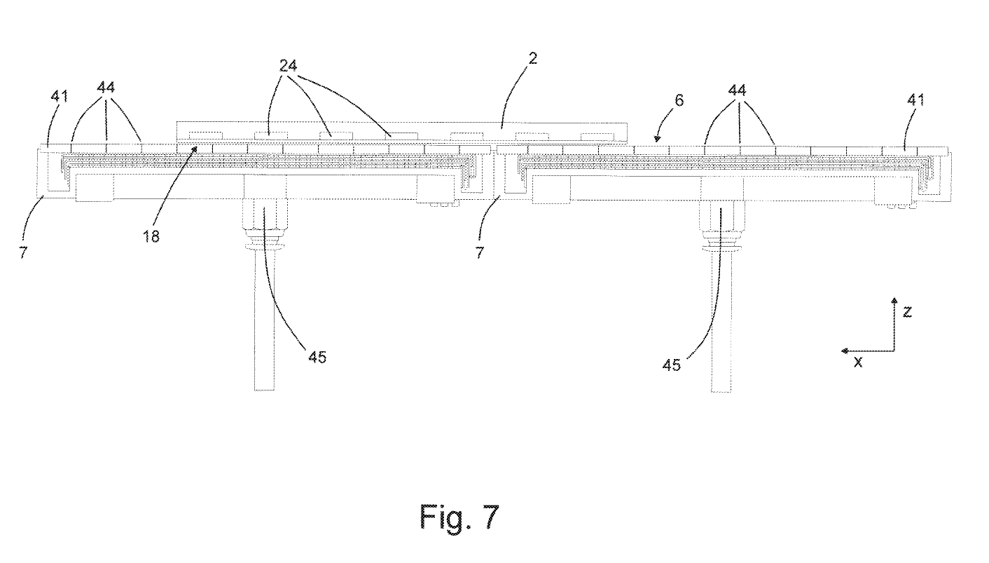

FIG. 7 is a sectional representation of two support modules arranged next to one another, on which a positioning carriage is arranged,

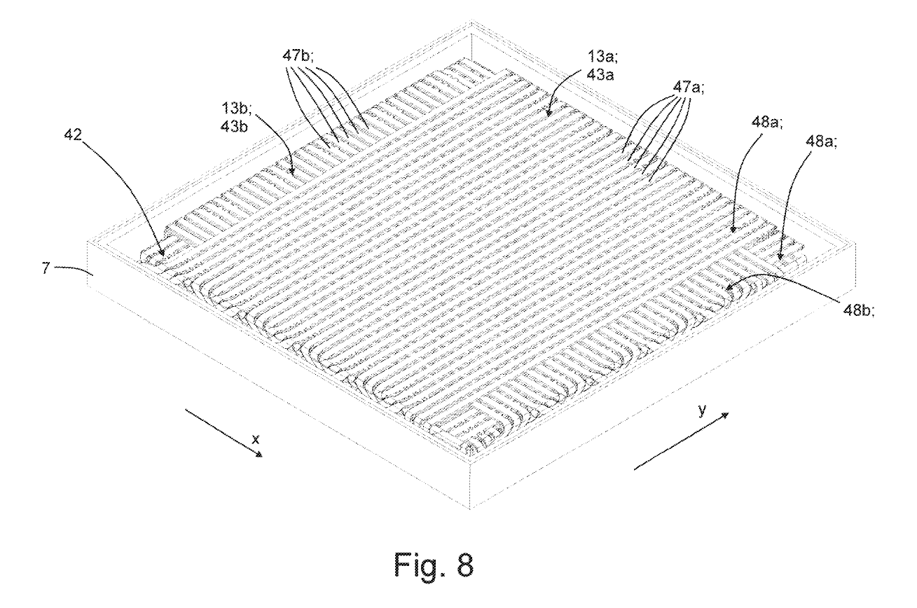

FIG. 8 is an isometric representation of a support module, in which the x-winding arrangement and the y-winding arrangement overlap according to a third embodiment of the invention,

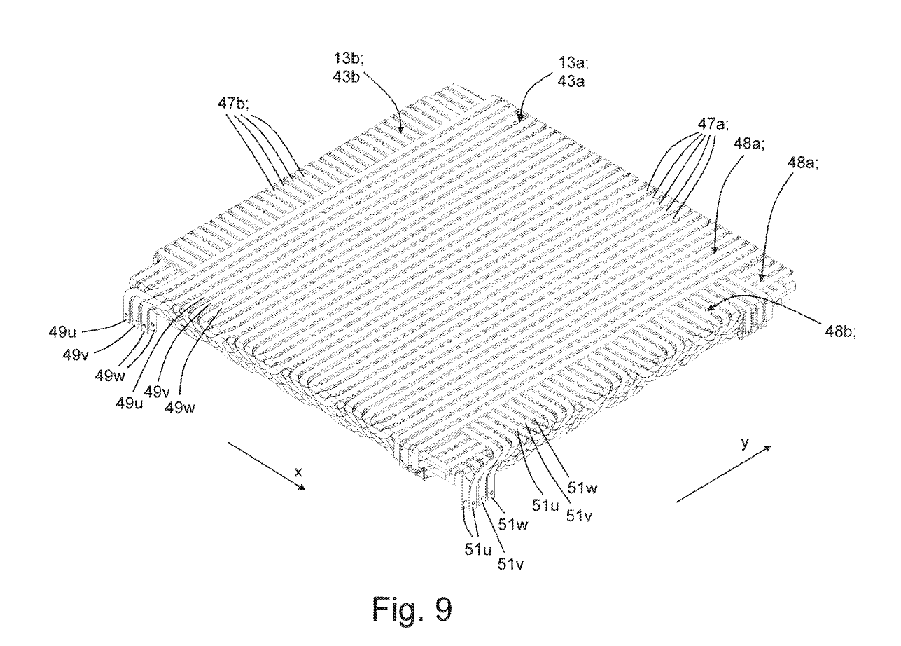

FIG. 9 is an isometric representation of the winding arrangement of the support module shown in FIG. 8,

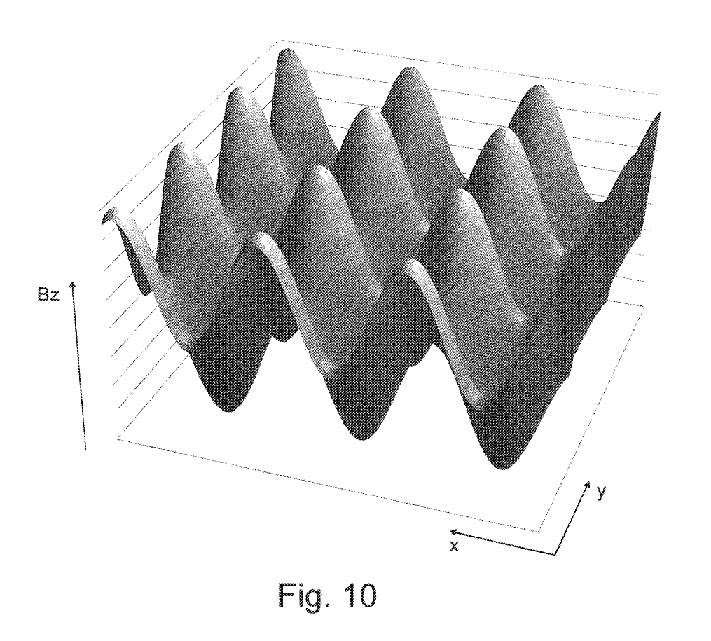

FIG. 10 is a schematic representation of a resulting magnetic field produced by the superposition of an x-travelling field and a y-travelling field.

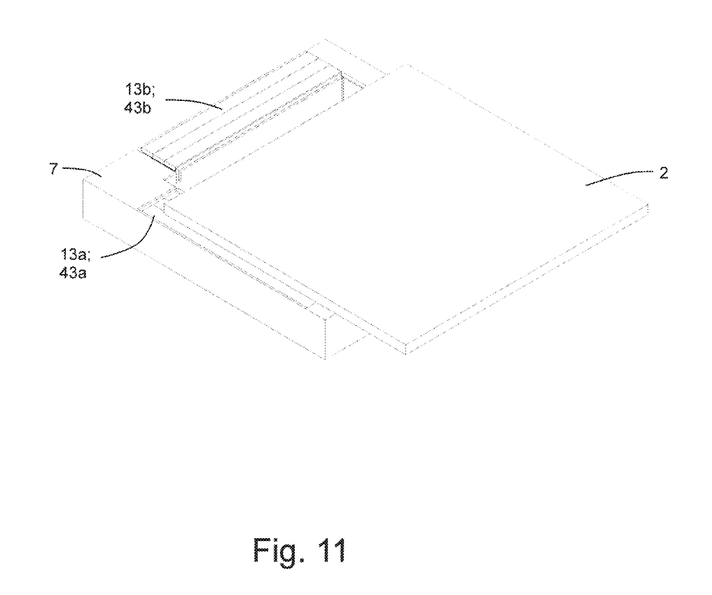

FIG. 11 is an isometric representation of a support module, in which the x-winding arrangement and the y-winding arrangement are arranged according to a fourth embodiment of the invention in an L-shape.

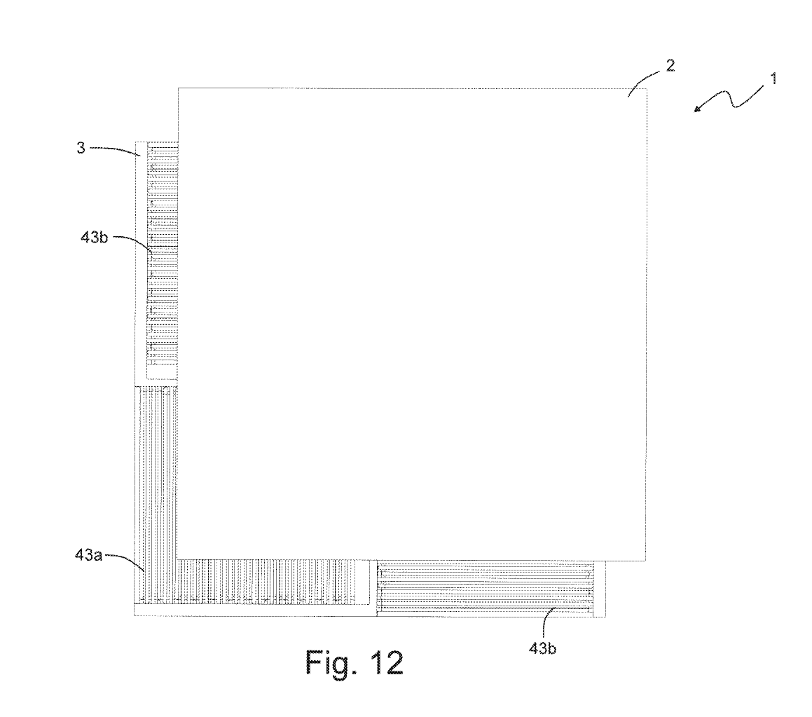

FIG. 12 is a plan view of a fifth embodiment of the positioning system according to the invention, wherein the winding arrangements have rectangular outlines and are arranged in the manner of a chessboard pattern

In the following description of the figures, the same designations are used for functionally identical components of the illustrated embodiments, wherein a repeated description of functionally identical components is omitted.

With reference to FIGS. 4, 5, 6, 8 and 11, it should be said that the module shown here may also represent an independent positioning system, in which the entire carriage support consists of a single support module, which is not necessarily designed to be linked together to further support modules. The entire carriage support of the positioning system can consist here uniformly of a single support module.

The positioning system identified overall by the reference numeral 1 contains at least one positioning carriage 2, which is mounted on a carriage support 3 acting as the base of the positioning system 1 and can be variably moved and positioned relative to the carriage support 3 in a positioning plane 5 by executing a positioning movement 4 illustrated by arrows.

The positioning plane 5 is defined by a Cartesian x-y coordinate system having an x-axis and a y-axis at right angles thereto. In the following description the direction of the x-axis will also be referred to as the x-axis direction, and the direction of the y-axis will also be referred to below as the y-axis direction. In FIGS. 1, 2 and 12, the x-axis and the y-axis and therefore the positioning plane 5 run parallel to the plane of the drawing. In FIGS. 6 and 7, the positioning plane 5 extends perpendicular to the plane of the drawing.

In a usual orientation of the positioning system 1 the positioning plane 5 is defined by a horizontal plane.

The carriage support 3 has a carrier upper side 6, which points vertically upwards in the usual orientation of the positioning system 1. The at least one positioning carriage 2 is arranged on the carrier upper side 6 on the carriage support.

FIG. 1 illustrates a first embodiment of the positioning system 1 according to the invention. Although the positioning system 1 comprises here several positioning carriages 2, the number of positioning carriages 2 is however in principle arbitrary. The positioning system 1 can also be equipped with only a single positioning carriage 2. References encountered hereinafter to a positioning carriage 2 should be understood as references to all respectively present positioning carriages 2.

The carriage support 3 expediently has a modular construction and is composed of a plurality of individual support modules 7. These support modules 7 can be arbitrarily arranged next to one another to form a two-dimensional module matrix in the x-y plane, and in particular can also be mechanically coupled to one another and/or to a support base plate 46, so as to form a fixed or coherent structure.

The carriage support 3 has a preferably plate-shaped main body structure 8. Each support module 7 has a main body 8a, wherein the support modules 7 with their main bodies 8a can be aligned next to one another in a modular arrangement, so that the multiple main bodies 8a arranged next to one another together form the main body structure 8.

Preferably each main body 8a has a rectangular outline. This rectangular outline is preferably square, which applies to the exemplary embodiments. Each main body 8a preferably has four mutually perpendicular lateral outer surfaces 12, which define the outline of the main body 8a.

Within the modular carriage support 3 the support modules 7 are aligned so that in each case two opposite lateral outer surfaces 12 are oriented in the x-axis direction and the other two opposite lateral outer surfaces 12 are oriented in the y-axis direction.

To form the carriage support 3, the support modules 7 can be linked together or are linked together with the lateral outer surfaces 12 of their main body 8a. In this way a carriage support 3 can be formed, which is composed of an arbitrary number of support module rows 7 running in the x-axis direction and an arbitrary number of support module rows running in the y-axis direction. Preferably, each of the four lateral outer surfaces 12 is suitable for the addition or attachment of a further support module 7, so that not only regular but also irregular distribution patterns of support modules 7 can be realised.

The carriage support 3 is provided with multiple stator sections 13a, 13b, which serve to provide travelling magnetic fields, with which the positioning carriages can be driven. At least one stator section 13a is responsible for the generation of an x-travelling magnetic field movable in the x-axis direction for the displacement of the positioning carriage 2 in the x-axis direction, and is therefore referred to as the x-stator section 13a. At least one other stator section 13b is responsible for the generation of a y-travelling magnetic field movable in the y-axis direction for the displacement of the positioning carriage 2 in the y-axis direction, and is therefore referred to as the y-stator section 13b.

The x-stator section 13a preferably comprises an x-winding arrangement that has a plurality of leads running parallel to the y-axis direction. Corresponding to this, the y-stator section 13b preferably comprises a y-winding arrangement that has a plurality of leads running parallel to the x-axis direction.

The carriage support 3 is provided with a drive circuit, with which the x-stator section 13a and the y-stator section 13b can be driven independently of one another so as to move the x-travelling field and the y-travelling field independently of one another. By coordinated activation of the stator sections 13a, 13b the direction of the positioning movement 4 can be set. In this way, not only is it possible to move a positioning carriage 2 selectively in the x-axis direction or in the y-axis direction, but also with any other direction of movement and type of movement within the positioning plan 5.

If the positioning system as shown in FIG. 1 comprises a plurality of x-stator sections 13a and y-stator sections 13b, then the drive circuit can be designed in such a way that the x-stator sections 13a and the y-stator sections 13b can in each case be controlled independently of one another. Accordingly, in the case of a carriage support 3 loaded with multiple positioning carriages 2, it is possible to move and position the positioning carriages 2 independently of one another.

It is possible to realise a positioning system 1 with only a single x-stator section 13a and only a single y-stator section 13b. Such a positioning system 1 then has for example the structure illustrated with reference to FIGS. 4 and 11, wherein the support module 7 shown here then forms the entire carriage support 3, which is designed as a unit. The particular advantage of the positioning system 1 is however manifested in particular when the carriage support 3 is equipped with a plurality of x-stator sections 13a and/or with a plurality of y-stator sections 13b, wherein it preferably has a plurality of x-stator sections 13a as well as a plurality of y-stator sections 13b. The latter applies to the exemplary embodiment illustrated in FIG. 1.

The described multiple equipment of the carriage support 3 with stator arrangements 13 has the advantageous effect that the positioning carriage 2 can be moved in a very large positioning range. One and the same positioning carriage 2 can change its output cooperation with travelling magnetic fields generated by different stator sections 13. The positioning carriage 2 can thus be passed between individual stator arrangements 13 during the positioning movement 4. As a result, the positioning carriage 2 can also cover longer distances on different trajectories. This allows a particularly flexible use of the positioning system 1.

When positioning within the positioning system 1, each positioning carriage 2 can in principle be moved across all existing support modules 7.

Each positioning carriage 2 is attached with an underneath side 18 from above to the carriage support 3. The underneath side 18 of the positioning carriage 2 and the carrier upper side 6 of the carriage support 3 are therefore facing one another in a height direction at right angles to the x-y plane, which could also be termed the z-axis direction.

The positioning carriage 2 has a magnet arrangement 23, which is preferably arranged on its underneath side 18. This magnet arrangement 23 is in magnetic interaction with the x-travelling field of at least one x-stator section 13a and the y-travelling field of at least one y-stator section 13b in each relative position of the positioning carriage 2 adopted with respect to the carriage support 3 in the positioning plane 5.

FIG. 2 shows the special configuration of the magnet arrangement 23. As shown in FIG. 2, the magnet arrangement 23 has a plurality of magnetic poles 24 arranged in the x-y plane with a regular two-dimensional distribution. The magnetic poles 24 are placed at crossing points of x-gridlines 30a and y-gridlines 30b at right angles to one another of an imaginary grid lattice, so that magnetic poles 24 placed on the same x-gridlines 30a have the same pole orientation N, S with one another. In other words, in each case only magnetic poles 24 of the same pole orientation are found on each x-gridline 30a. Corresponding to this, magnetic poles 24 placed on the same y-gridlines 30b have the same pole orientation N, S with respect to one another. In the diagonal direction 30c of the x-y coordinate system the pole orientation N, S of the magnetic poles 24 alternates.

The x-gridlines 30a are gridlines running in the x-axis direction and the y-gridlines 30b are gridlines running in the y-axis direction. The x-gridlines 30a intersect the y-gridlines 30b at right angles and are all in one and the same x-y plane. The mutual distance between the respectively adjacent x-gridlines 30a is preferably the same, as is the mutual distance between the respectively adjacent y-gridlines 30b. Preferably the distance between the respectively adjacent x-gridlines 30a is also the same length as the mutual distance between the respectively adjacent y-gridlines 30b. Each magnetic pole 24 is preferably identically spaced with respect to the magnetic poles 24 adjacent to it in the x-axis direction and the y-axis direction.

The magnet arrangement 23 expediently has a rectangular outer contour in the x-y plane. Preferably, the positioning carriage 2 seen in plan view has a rectangular outline, wherein the magnet arrangement 23 extends to all four lateral edge regions of the positioning carriage 2.

In the example shown in FIG. 2, seven magnetic poles are respectively arranged on each x-gridline 30a and y-gridline 30b. The number of magnetic poles arranged on the gridlines can expediently also be larger or smaller.

If the x-travelling field is moved, it displaces the positioning carriage 2 in the x-axis direction due to the magnetic interaction, wherein at the same time the stationary y-travelling field in conjunction with the special configuration of the magnet arrangement 23 prevents a displacement of the positioning carriage 2 in the y-axis direction and thus causes a linear guidance. In a similar way a movement of the y-travelling field 13b effects a positioning movement 4 of the positioning carriage 2 in the y-axis direction, wherein the stationary x-travelling field in conjunction with the afore-described special design of the magnet arrangement 23 effects a linear guidance of the positioning carriage 2 in the y-axis direction.

FIG. 3 shows a second embodiment of the positioning system 1 according to the invention. As shown, the carriage support 3 here comprises a plurality of support modules 7 aligned next to one another, which are arranged on a carrier base plate 46. On each support module 7, an air cushioning plate 41 is arranged. The air cushioning plates 41 have substantially the same outline as the support modules, so that together they form an almost continuous bearing surface. Each air cushioning plate 41 has a plurality of air outlet openings 44. During operation of the positioning system 1 the support modules 7 are supplied with compressed air, which leaves the air outlet openings 44 and thus provides an air cushion with which the positioning carriage 2 can be supported.

At this point it should be mentioned that the air outlet openings 44 are shown purely schematically in the figures. The diameter of the air outlet openings 44 was chosen to be relatively large for the purposes of visibility. In fact, the diameter of the air outlet openings can however also be dimensioned much smaller than shown.

FIGS. 4, 5 and 6 show respectively a single support module 7 from the positioning system 1 shown in FIG. 3. FIG. 5 is an isometric sectional view of a support module 7, and shows in particular the winding chamber 42 provided in the support module 7 as well as the winding arrangement 43 installed therein. The winding arrangement 43 includes the leads of the stator arrangement 13, which are electrically energised accordingly for the purpose of providing the travelling magnetic fields. In the illustrated example the main body 8a of the support module 7 is closed at the sides and downwardly and is designed to be upwardly open. The air cushioning plate 41 lies on top on the main body 8a, which therefore defines together with the side walls and the base of the main body 8a the winding chamber 42. Preferably, the air cushioning plate is connected in an airtight manner to the main body 8a, so that compressed air introduced into the winding chamber 42 during the operation of the positioning system can expediently escape only through the air outlet openings 44. As shown in FIGS. 5 and 6, the base body 8a has a compressed air inlet 45 at the bottom on the base, through which supplied compressed air can be introduced into the winding chamber 42. Since the compressed air inlet 45 is arranged on the side of the winding arrangement opposite the air cushioning plate 41, the supplied compressed air inevitably flows through the winding arrangement 43 before it leaves from the air outlet openings. The compressed air supplied for providing the air bearing can thus advantageously be used to cool the winding arrangement 43.

FIG. 7 shows a sectional view of two support modules 7 arranged next to one another. As can be seen in FIG. 7, the support modules 7 and the positioning carriage 2 are designed so that the positioning carriage 2 can be conveyed from a support module 7 to an adjacent support module 7. In particular the support modules 7 are to this end aligned flush with one another in the z-direction. Furthermore, the respective winding arrangements 43 are designed or driven in such a way that the positioning carriage 2 can be driven simultaneously by travelling magnetic fields of both support modules. For this purpose, the respective winding arrangements 43 are designed or driven in such a way that the travelling magnetic field of one support module 7 is equal or corresponds to an imaginary periodic continuation of the adjacent support module 7.

FIG. 8 shows a support module 7 of a third embodiment of the invention. The air cushioning plate 41 is not shown here for the sake of better visibility of the winding arrangement 43. The winding arrangement 43 includes the x-winding arrangement 43a of the x-stator portion 13a and the y-winding arrangement 43b of the y-stator portion 13b. The special feature here is that the x-winding arrangement 43a and the y-winding arrangement 43b overlap, that is, they occupy the same x-y range, so that the x-travelling field and y-travelling field provided by these winding arrangements 43a, 43b overlap in this x-y range. As shown in FIG. 8, the two winding arrangements 43a, 43b overlap almost completely. In particular, the overlapping surface of the winding arrangements is larger than the non-overlapping surface of the winding arrangement.

The x-winding arrangement 43a comprises a plurality of x-leads 47a running parallel to the y-axis direction, which are arranged in one or more x-planes 48a parallel to the positioning plane 5. Correspondingly, the y-winding arrangement 43b comprises a plurality of y-leads 47a running parallel to the x-axis direction, which are arranged in one or more y-planes 48b parallel to the positioning plane 5.

As can be seen in FIG. 8, x- and y-planes 48a, 48b lie one above the other in the z direction—i.e. perpendicular to the x-y coordinate system—that is, they are stacked on top of one another in the z direction. The x- and y-planes 48a, 48b are arranged alternately in the z direction. In plan view, this therefore forms a winding matrix, in which the x-leads 47a and the y-leads 47b intersect in a plurality of crossing points.

Several advantages result from the overlapping of the x-winding arrangement 43a and the y-winding arrangement 43b. A first advantage is that, due to the overlapping, both winding arrangements can occupy almost the entire x-y area of the support module 7 and therefore the area of the support module 7 is utilised efficiently. Travelling magnetic fields can thereby be provided, which extend both in the x-axis direction and also in the y-axis direction almost over the entire x-y region of the support module 7.

A further advantage is that the magnetic field resulting from the superposition of the travelling magnetic fields is particularly well suited to drive the afore-described magnet arrangement 23.

In particular, if the travelling magnetic fields, as described hereinbefore, respectively have a plurality of parallel wavefronts, then a resulting magnetic field is obtained due to the superposition of the two travelling fields, the magnetic field strength of which comprises a plurality of maxima and minima and north poles and south poles distributed like a matrix over the overlapping surface of the winding arrangements. FIG. 10 shows an exemplary configuration of such a magnetic field for the case where the x-travelling field and the y-travelling field are each formed sinusoidally. The magnetic field strength Bz—i.e. the magnetic field strength in the direction perpendicular to the positioning plane 5—is plotted on the z-axis of the diagram shown in FIG. 10.

The resulting magnetic field corresponds as regards its basic geometry to the magnetic field provided by the magnetic arrangement 23—in each line and each row of which respectively only magnetic poles of the same pole orientation are present, and in the diagonal direction the pole orientation of the magnetic poles alternates. The resulting magnetic field is therefore particularly well suited to drive the magnet arrangement.

The leads of the winding arrangements are arranged in such a way and/or are energised by the drive circuit in such a way that a resulting magnetic field is produced by the superposition, the magnetic north and south poles of which are arranged in inverse correspondence to the north and south poles of the afore-described magnet arrangement 23 and are accordingly spaced from one another. Thus, each south pole of the magnet arrangement 23 can be entrained by a north pole of the resulting magnetic field, and each north pole of the magnet arrangement 23 can be entrained by a south pole of the resulting magnetic field. Owing to this formation of the resulting magnetic field, the magnet arrangement of the positioning carriage can be carried along particularly well with the resulting magnetic field.

FIG. 9 shows the overlapping x- and y-winding arrangements 43a, 43b of the support module 7 shown in FIG. 8. In the illustrated example both the x-leads 47a and also the y-leads 47b are divided into three groups of leads. The x-leads 47a are divided into the groups of leads 49u, 49v and 49w and the y-lines 47b are divided into the groups of leads 51u, 51v and 51w. As shown, in the x-axis direction leads of the groups of leads 49u, 49v, and 49w are arranged next to one another, and this arrangement is repeated periodically along the x-axis direction. In the y-axis direction the arrangement of leads of the groups of leads 51u, 51v and 51w is correspondingly repeated periodically.

Leads of the same group of leads carry the same current. For this purpose the leads of the same group of leads are connected in series to one another. In the example shown in FIG. 9, for this purpose in each case two adjacent leads of the same group of leads are connected to one another at the side edge of the winding arrangement 43. The connecting section is in this case bent downwards so as to make efficient use of the existing space. Leads of the same group of leads in different levels are also connected in series to one another.

The result is therefore an arrangement in which effectively one lead line is provided per group of leads, which is arranged in a meandering manner along the x- or y-axis direction and runs through all the associated x- or y-planes.

FIG. 11 shows a support module 7 of a fourth embodiment of the invention. In contrast to the embodiment shown in FIG. 8, here the x-winding arrangement 43a and the y-winding arrangement 43b do not overlap, but are arranged in an L-configuration. The longitudinal axis of the x-winding arrangement 43a in this case lies on one L-leg, while the longitudinal axis of the y-winding arrangement 13b lies on the other L-leg of the L-shaped configuration. At the same time an axial end region 33a of the x-winding arrangement 43a is arranged adjacent to an axial end region 33b of the y-winding arrangement 43b. The x-winding arrangement 43a comprises a plurality of leads running parallel to the y-axis direction and arranged in a plane parallel to the positioning plane 5. Corresponding to this, the y-winding arrangement 43b comprises a plurality of leads running parallel to the x-axis direction, which are arranged in a plane parallel to the positioning plane 5.

FIG. 12 shows a positioning system according to a fifth embodiment. In this embodiment multiple x-winding arrangements 43a and y-winding arrangements 43b are provided. The x-winding arrangements and the y-winding arrangements are arranged parallel to the positioning plane 5 and respectively have rectangular, almost square outlines. The side lengths of the x-winding arrangements 43a and of the y-winding arrangement 43b substantially coincide in the x-axis direction and the y-axis direction of the x-y coordinate system. The x-winding arrangements 43a and y-winding arrangements 43b are arranged in the manner of a chessboard pattern, that is, the x-winding arrangements 43a and y-winding arrangements 43b are alternately arranged along the x-axis direction and the y-axis direction.

The following description refers to all the afore-described embodiments.

If a carriage support 3 is equipped with a plurality of x-stator sections 13a and/or y-stator sections 13b and the interaction of these stator sections 13a, 13b with the positioning carriage 2 changes, a suitable monitoring system is expediently present that provides for a seamless transition of the positioning carriage 2 between the individual stator sections 13a, 13b and ensures that the current position of the positioning carriage 2 is known, so that by selective control of the stator sections 13a, 13b, the desired positioning movement 4 of the positioning carriage 2 can be generated.

The carriage support 3 can be equipped at one or more points with sensor means, which allow a position detection of the at least one positioning carriage 2, and in fact conveniently separately for the current position in the x-axis direction and the current position in the y-axis direction. Corresponding position detection means can operate for example on an optical or magnetic basis.

The positioning carriages 2 can, depending on their design, be used to carry products to be supplied directly for a specific purpose or also to receive separate product carrier means that can be loaded with products. One possible application is the use of the positioning carriage 2 for carrying so-called microtiter plates, which are used in laboratory automation to store fluid samples. Independently of the manner in which a positioning carriage 2 can be equipped or is equipped with one or more products, the positioning carriage 2—in particular on its underneath side 18—can be provided with a readable coding, which allows for a product identification and which is readable by an identification device arranged for example on the carriage support 3 at a certain place or at several places. Such a coding can also be used for the position control.

In particular in the case of large transport systems the positioning system 1 can also be equipped with RFID identification means.

1. A positioning system, comprising at least one positioning carriage which is variably movable and positionable relative to a carriage support of the positioning system by executing a positioning movement on a positioning plane defined by a Cartesian x-y coordinate system,
wherein the carriage support comprises at least one stator arrangement having an x-stator section for providing an x-travelling magnetic field movable in the x-axis direction of the x-y coordinate system and a y-stator section for providing a y-travelling magnetic field movable in the y-axis direction of the x-y coordinate system, and
wherein the positioning carriage has a magnet arrangement, which during the positioning movement at the same time magnetically interacts with the x-travelling field and with the y-travelling field, and the positioning carriage can be driven by movement of the x-travelling field to a positioning movement in the x-axis direction of the x-y coordinate system and by movement of the y-travelling field to a positioning movement in the y-axis direction of the x-y coordinate system, and
wherein the magnet arrangement of the positioning carriage has a plurality of magnetic poles distributed in a plane parallel to the positioning plane, which magnetic poles are placed at crossing points of mutually right-angled x-gridlines and y-gridlines of an imaginary grid lattice in such a way that magnetic poles placed on the same x-gridlines have the same pole orientation with respect to one another, and magnetic poles placed on the same y-gridlines have the same pole orientation with respect to one another, and
wherein the pole orientation of the magnetic poles alternates in the diagonal direction of the x-y coordinate system, and
wherein the carriage support comprises a plurality of support modules, which can be modularly arranged or are modularly arranged next to one another in the x-axis direction and/or in the y-axis direction and respectively contain at least one x-stator section and/or at least one y-stator section, wherein one and the same positioning carriage can during its positioning movement move over several and expediently over all of the support modules.

2. The positioning system according to claim 1, further comprising at least one bearing device arranged between the carriage support and the positioning carriage, which movably supports the positioning carriage in the x-axis and y-axis direction.

3. The positioning system according to claim 2, wherein the bearing device comprises an air cushioning plate, which, on the side facing towards the positioning carriage, comprises a plurality of air outlet openings for providing an air bearing supporting the positioning carriage.

4. The positioning system according to claim 3, wherein the carriage support has at least one winding chamber, in which a winding arrangement of the stator arrangement is arranged, wherein the winding chamber is closed off in the direction to the positioning carriage by the air cushioning plate and, on the side of the winding arrangement facing away from the air cushioning plate, has a compressed air inlet, so that air cushioning compressed air provided at the compressed air inlet has to flow through the winding chamber and the winding arrangement in order to reach the air outlet openings.

5. The positioning system according to claim 1, wherein the at least one positioning carriage is designed as a product carrier, which can be loaded directly or indirectly with at least one product to be positioned.

6. The positioning system according to claim 1, wherein the at least one positioning carriage has a rectangular outline and/or is plate-shaped.

7. The positioning system according to claim 1, wherein the x-stator section has an x-winding arrangement, which comprises a plurality of x-leads running parallel to the y-axis direction, and the y-stator section has a y-winding arrangement, which comprises a plurality of y-leads running parallel to the x-axis direction.

8. The positioning system according to claim 7, wherein the x-winding arrangement and the y-winding arrangement are arranged parallel to the positioning plane in an L-shaped configuration, wherein an axial end region of the x-winding arrangement is placed adjacent to an axial end region of the y-winding arrangement.

9. The positioning system according to claim 7, wherein the x-winding arrangement and the y-winding arrangement are arranged parallel to the positioning plane and occupy at least partially the same x-y region in the x-y-coordinate system, so that the x-travelling field and the y-travelling field overlap in this x-y region.

10. The positioning system according to claim 7, wherein the winding arrangements of the two stator sections are arranged parallel to the positioning plane and have respectively rectangular, outlines, wherein the side lengths of the winding arrangements in the x-axis direction and y-axis direction of the x-y coordinate system substantially coincide.

11. The positioning system according to claim 1, wherein the carriage support is equipped with a plurality of x-stator sections and/or with a plurality of y-stator sections.

12. The positioning system according to claim 1, wherein the carriage support has at least one drive circuit, which is designed to supply multiple, mutually phase-shifted currents to at least one x-stator section and/or at least one y-stator section for the provision of the respective travelling field.

13. The positioning system according to claim 12, wherein the drive circuit is designed to supply at least two stator arrangements of the carriage support independently of one another with in each case multiple, mutually phase-shifted currents in order to provide the travelling magnetic fields associated with the at least two stator arrangements independently of one another.

14. (canceled)

15. The positioning system according to claim 1, wherein the base area of the magnet arrangement of at least one positioning carriage is larger or smaller than the base area of the carriage support or each support module.
